(19) United States
(12) Patent Application Publication
(10) Pub. No.: US 2026/0066536 A1
(43) Pub. Date: Mar. 5, 2026

(54) Switched Splitter-Combiner for Local Excitation of Wideband Antenna Arrays

(71) Applicant: Cheshir Industries Inc., Albuquerque, NM (US)

(72) Inventors: Nicolas Garcia, Albuquerque, NM (US); Nicholas Estes, Albuquerque, NM (US)

(21) Appl. No.: 19/310,517

(22) Filed: Aug. 26, 2025

Related U.S. Application Data
(60) Provisional application No. 63/690,368, filed on Sep. 4, 2024.

(51) Int. Cl. H01Q 3/46; H01Q 19/06; H01Q 19/10

(52) U.S. Cl. CPC H01Q 3/46; H01Q 19/06; H01Q 19/10

(57) ABSTRACT

Tightly coupled array antennas exhibit wideband behavior when all elements are excited simultaneously. A switched splitter-combiner allows a scalable number of adjacent feed elements of the array to be excited depending on the frequency of excitation and degree of coupling. This allows the tightly coupled array to be locally excited while retaining wideband performance. The performance may be further improved by complex per-element control of excited elements or tunable reactive termination of non-excited elements.

### TECHNICAL FIELD

This patent application is related to obtaining a wide impedance bandwidth from a local excitation of tightly coupled arrays by enabling the excitation of a scalable number of adjacent antennas.

### BACKGROUND

Gradient index (GRIN) lens antennas are an extremely promising alternative to conventional beamscanning antenna topologies, being both highly power-efficient and cost-effective.

FIG. 1A depicts a GRIN lens antenna, which comprises a low-directivity feed antenna (101) coupled to a GRIN lens (100).

The GRIN lens (100) collimates power radiated (102) quasi-spherically by the feed antenna (101) such that the output phase contours (103) have reduced curvature. The far-field gain of the GRIN lens antenna is substantially higher than that of the feed alone.

The GRIN lens (100) can be interpreted as either a lens that focuses an incident plane wave onto the feed (101) or a lens that transforms the feed fields (102) to a high-efficiency aperture antenna at the lens's radiating surface.

By suitable design optimization, the GRIN lens (100) may be so designed that it possesses a “focal plane” (depicted in FIG. 1B, 106). Plane waves incident from different angles (azimuth/elevation) on the lens are focused to different points beneath the lens.

By reciprocity, by changing the location of the feed (104) with respect to the antenna, the direction of the beam formed by collimation of the feed radiation changes in angle space (105).

Although the beam may be steered by mechanical translation of the feed, it is more convenient in many cases to build an array of feeds behind the lens. FIG. 1B shows such an array of feeds (107). By using switches (not shown) to control the active feeds (108), a GRIN lens antenna may be electronically scanned like a phased array. We will refer to this architecture as a “switch-beam GRIN lens antenna”. An example resulting beam is shown (109). The switch-beam GRIN lens antenna is the architecture of interest, in the context of which the present embodiments are designed.

The beamforming element of the switch-beam GRIN lens antenna (the lens 100) is a purely passive device: complicated and power-hungry phase shifters/variable gain amplifiers (as in an analog phased array) and numerous ADCs/DACs (as in a digital phased array) are not required.

Therefore, switch-beam GRIN lens antennas are of great interest as low-power, low-cost, low-complexity alternatives to conventional beamformers such as analog or digital phased array antennas.

GRIN lenses are typically true time delay (TTD) optical or quasi-optical structures, like conventional homogeneous lenses.

The difference between GRIN lenses and conventional homogeneous lenses is that GRIN lenses permit the material characteristics (typically permittivity) of the lens to vary throughout the lens volume. This material variation permits the inclusion of impedance matching structures (tapers) within the lens, allowing a wideband impedance match to free space. Because of the TTD operation and impedance matching, GRIN lenses can be designed to operate across an extremely wide bandwidth. The ratio of highest frequency of operation to lowest frequency of operation of the GRIN lens itself may exceed 10:1.

The wide bandwidth operation of GRIN lenses is of special interest because phased array antennas are typically, though not necessarily, narrowband; an extremely wideband switch-beam GRIN lens antenna could potentially substantially reduce the cost and complexity of wideband beamscanning by replacing five or six equivalent phased array antennas.

### SUMMARY

Although the GRIN lens itself may be extremely wideband, a switch-beam GRIN lens antenna system requires that the feeding array is equivalently wideband. The design of a locally excited extremely wideband antenna array is the topic of this patent.

One aspect of the difficulty is that the feed array itself needs to have an extremely wide impedance bandwidth. The impedance bandwidth describes the range of frequencies over which an antenna will efficiently accept power.

For an antenna exhibiting low conductor and dielectric losses, good matching to the source implies that most of the power available from the source is being radiated by the antenna. All else being equal, more efficient radiation from an antenna results in higher sensitivity wireless receivers and longer-range wireless transmitters. Therefore, high antenna efficiency from a matching standpoint is extremely desirable.

Often, an antenna is only considered to be working well over a given bandwidth if it accepts more than 90% of the power available from the source.

There are several methods for the design of isolated antennas that exhibit extremely wide impedance bandwidths. Beyond well-known wideband canonical antennas such as ridged horns or Vivaldi antennas, several classes of extremely wideband antennas are known to exist, including traveling wave antennas, self-complementary antennas (e.g. spiral antennas), and antennas defined only by angles (e.g. biconical antennas).

However, it is also well-known that to make extremely wideband arrays of antennas, it is not sufficient to design a wideband antenna in isolation and then construct an array by repetition of that element in a 2-D plane.

For both switch-beam GRIN lens antennas and phased arrays, the spacing between elements of the array, the so-called element-to-element spacing is typically small. For a given free-space wavelength “λ” and depending on the desired field of view, phased arrays must maintain element-to-element spacing of at most 1λ and typically no more than 0.5λ to avoid spurious emissions at grating lobes at all frequencies of operation. Since λ is smallest at the highest frequency of operation, element-to-element spacing is set by the highest frequency of operation. Elements are substantially electrically closer together at the low end of the array's bandwidth.

While a switch-beam GRIN lens antenna does not exhibit grating lobes, the density of feed elements is in general expected to be similar to the density of elements in a phased array. Therefore, we may use insights on wideband arrays from the phased array literature.

Because of the close element-to-element spacing, adjacent array elements in wideband antenna arrays always exhibit strong coupling, especially at the lowest operating frequencies. This coupling results in several problems. Firstly, coupling alters the input impedance of each antenna, and so each element needs to be designed in the context of an array, and the bandwidth of the antenna may be reduced. Second, power coupling to adjacent elements can be dissipated in the adjacent elements'terminations, reducing the array efficiency by reducing the amount of power radiated. Third, the radiation pattern of the isolated antenna is altered by the presence of electrically close antennas.

For phased arrays, extremely wideband arrays (e.g. >5:1) can be implemented by what are known as “tightly coupled” arrays such as the tightly coupled dipole array (TCDA) or tightly coupled Vivaldi array (TCVA). An example TCVA (200) is depicted in FIG. 2. The elements (201) of a TCVA (200) are metal cut into tapers with close element-to-element spacing (203) and are essentially continuously-connected Vivaldi antennas. The antennas are typically fed by a balun at the location on each element indicated by (202).

Because each element in a phased array is assumed to have the same magnitude excitation, the arrays admit periodic analysis techniques. Specifically, such arrays are usually designed and optimized using computer aided design (CAD) techniques that enforce periodic (Floquet) boundary conditions.

Tightly coupled arrays are designed to take advantage of the coupling instead of mitigating it. The extremely wide operating bandwidth of tightly coupled arrays is observed only for excitations in which the elements are all excited at similar magnitude with a linear phase shift across the array. In this case, the coupling of adjacent elements ideally “cancels out” in aggregate and there is no reflected wave traveling back toward each element's source. The array is therefore said to have low “active return loss”, or low reflection when the entire array is excited. Because the coupling is strong, each individual element relies on coupling to cancel out the reflected wave - that is, if only one element is excited in the array, there is strong power loss to adjacent elements and an impedance mismatch to the source.

This assumption of simultaneous feed excitation poses a problem for the design of wideband tightly coupled arrays operating as GRIN lens feeds. Because a GRIN lens maps a location in the feed plane to an angle in beam space, a wideband switch-beam GRIN lens feed array must be excited locally—that is, with only one (or very few) array element(s) active at any given time—to take advantage of the collimation of the GRIN lens. However, this local excitation breaks the assumption of full array excitation and causes impedance bandwidth degradation. A solution is needed to adapt these well-known tightly-coupled arrays to support local excitation for use as wideband GRIN lens antenna feed arrays.

In practice, the coupling between adjacent elements (201) increases as the frequency lowers, because the antennas become electrically close, especially as the fractional operating bandwidth increases. This means that at the top of the band, both the impedance mismatch and coupling loss may be acceptably low and a single element excitation is acceptably efficient.

However, as the frequency of excitation lowers, the coupling between adjacent elements increases. It is well known that the performance of the elements in an infinite phased array may be approximated by the performance of an element in a finite but “sufficiently large array”.

Therefore, the acceptable local excitation is expected to be a continuum from an assumedly acceptable high-frequency single-element excitation performance. As single-element excitation performance degrades with the lowering of excitation frequency, we anticipate that the in-phase excitation of two adjacent elements will yield acceptable impedance performance, then three, then more as frequency continues to drop.

Although this approach is useful in the context of GRIN lens antennas, it is generally suitable for any scenario in which the local excitation of an array is desired.

Such applications include power-scalable wideband analog or hybrid phased arrays, wideband feed arrays for non-GRIN lens antennas, and wideband feed arrays for reflector antennas.

The apparatus and methods described herein relate to a configuration of splitter circuits and switches that allow an incident excitation to be divided between one, two, or more antennas to mitigate the degradation in efficiency due to interelement coupling.

### BRIEF DESCRIPTION OF DRAWINGS

The foregoing and other features will be more readily apparent from the following detailed description and drawings of illustrative embodiments in which:

FIG. 1A and FIG. 1B are illustrations of a GRIN lens antenna and array-fed GRIN lens antenna, respectively.

FIG. 1 2 is an illustration of an example of a one-dimensional tightly coupled Vivaldi array (TCVA).

FIG. 3 is an illustration of the switched splitter-combiner in the context of an antenna array and associated RF circuitry.

FIG. 4A, FIG. 4B, FIG. 4C, FIG. 4D, FIG. 4E and FIG. 4F are depictions of nonlimiting embodiments. FIG. 4A illustrates a switched splitter-combiner that can excite 1 or 2 antennas simultaneously. FIG. 4B illustrates a switched splitter-combiner that can excite 1, 2, or 4 antennas simultaneously. FIG. 4C and FIG. 4D illustrate a switched splitter-combiner that can excite 1 or 2 antennas simultaneously with any two adjacent antennas so excitable. FIG. 4E and FIG. 4F illustrate embodiments that allow for independent element gain/phase control or tunable impedance terminations, respectively.

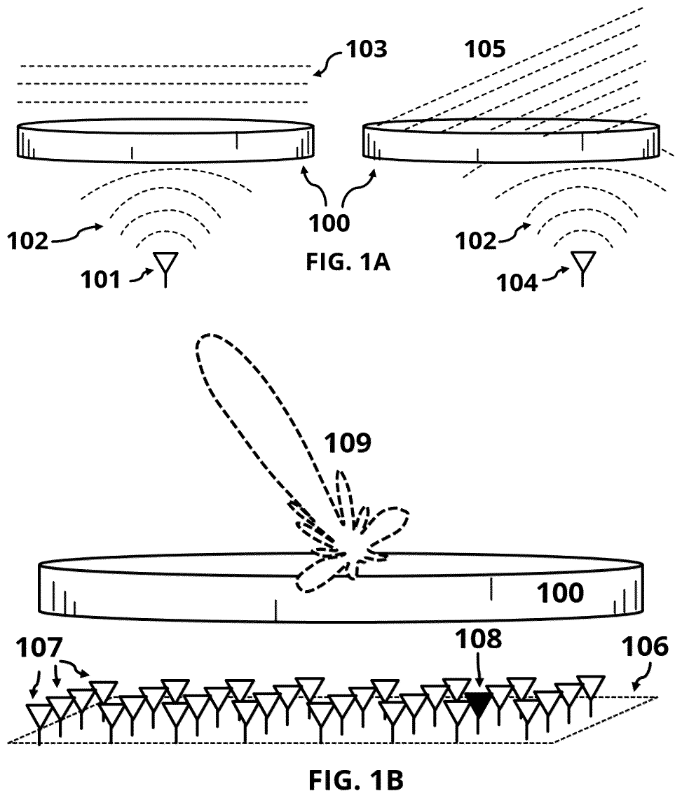

### DETAILED DESCRIPTION

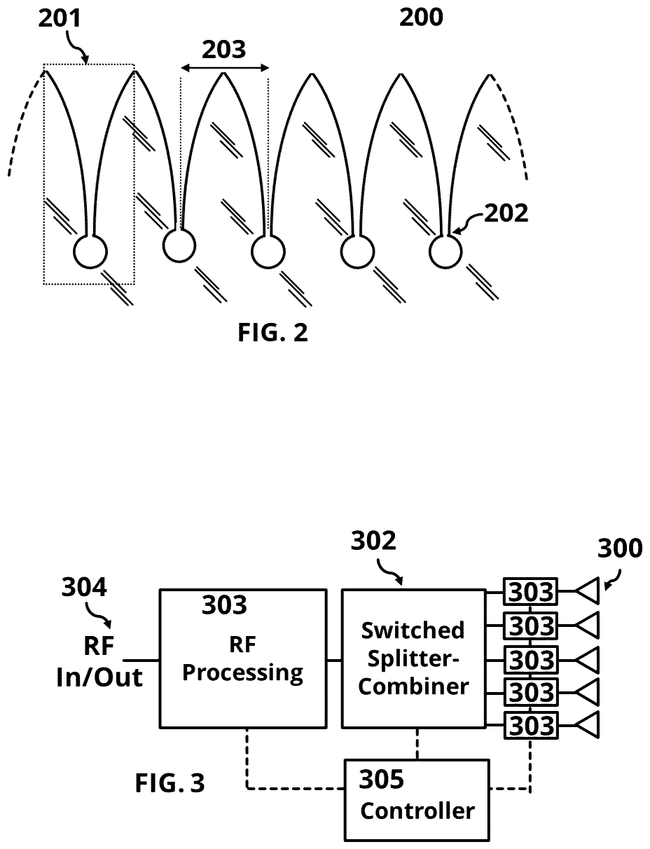

We describe a switched splitter-combiner circuit to allow a single excitation to multiple feed antennas to obtain wide bandwidth operation despite exciting a tightly coupled array locally. A simplified architecture is first shown in FIG. 3, with non-limiting example embodiments to be described afterward. At least one RF port (304) is connected to a set of feed antennas (300) via a switched splitter-combiner circuit (302).

RF processing (303) may occur prior to and/or after the switched splitter-combiner network (302). Such processing (303) may include but is not limited to transmit-receive switching, phase shifting, impedance matching, duplexing, low noise amplification, power amplification, and/or filtering.

The switched splitter-combiner (302) is designed such that the power incident from the RF port (304) may be dynamically routed to all or a subset of the antennas (300). In most practical embodiments, we expect the power delivered to each excited antenna to be equal, but unequal excitations are possible.

Real-time digital configuration via is employed via a controller (305) to configure the antenna, including all functions of the RF processing (303) blocks and switched-splitter combiner (302). Such control may be effected via analog or digital signals.

Antenna logic may be controlled entirely onboard with, e.g., an embedded computer, or the controller (305) may be part of a wider control plane (not shown) for multi-antenna optimization. Although simple connections between controller (305) and the RF processing blocks (303) and switched splitter-combiner (302) is shown via dashed line in FIG. 3, such control may also take into account outputs supplied by the dependent blocks (303, 302), in, e.g., closed-loop control. The simplified diagram of FIG. 3 does not prohibit more complex implementations.

In practice, we expect to excite many antenna elements simultaneously at the low end of the operating band and few (even one) at the high end of the band.

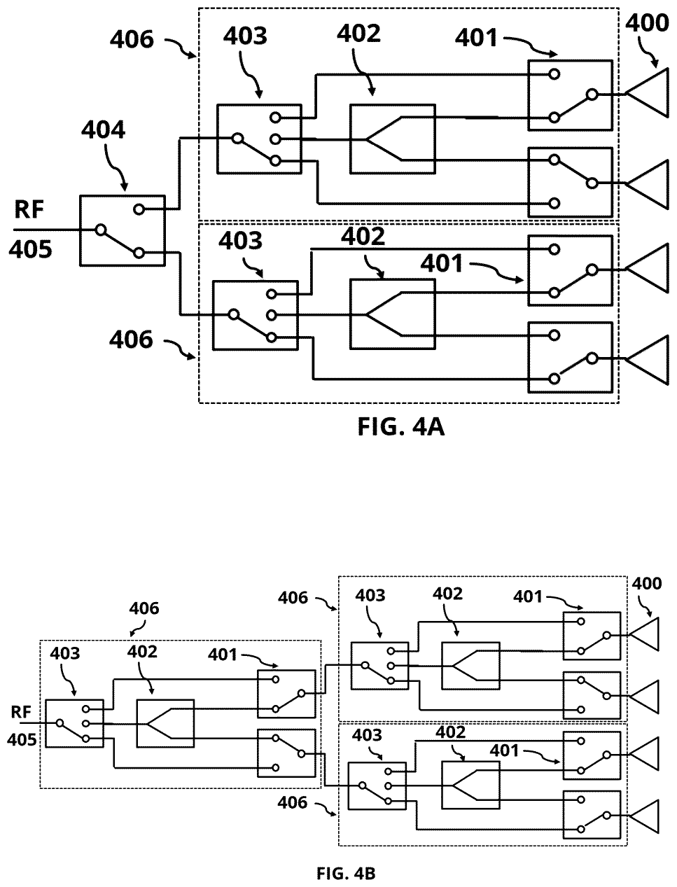

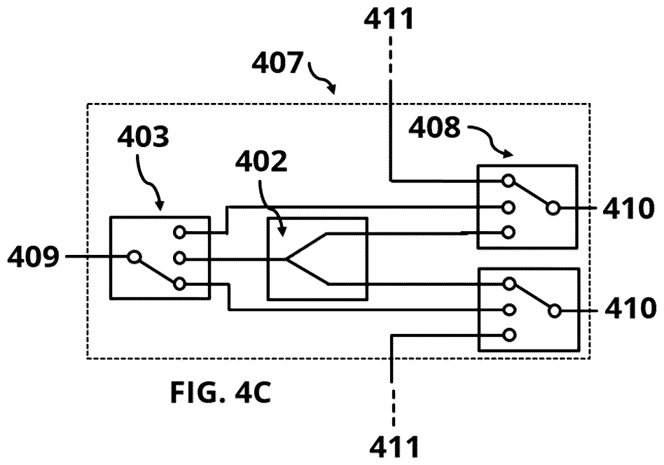

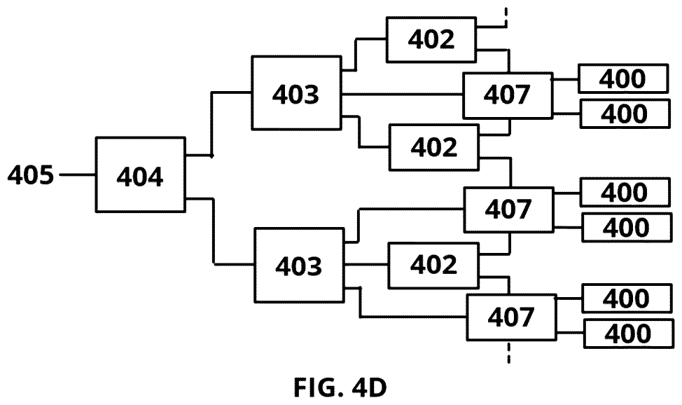

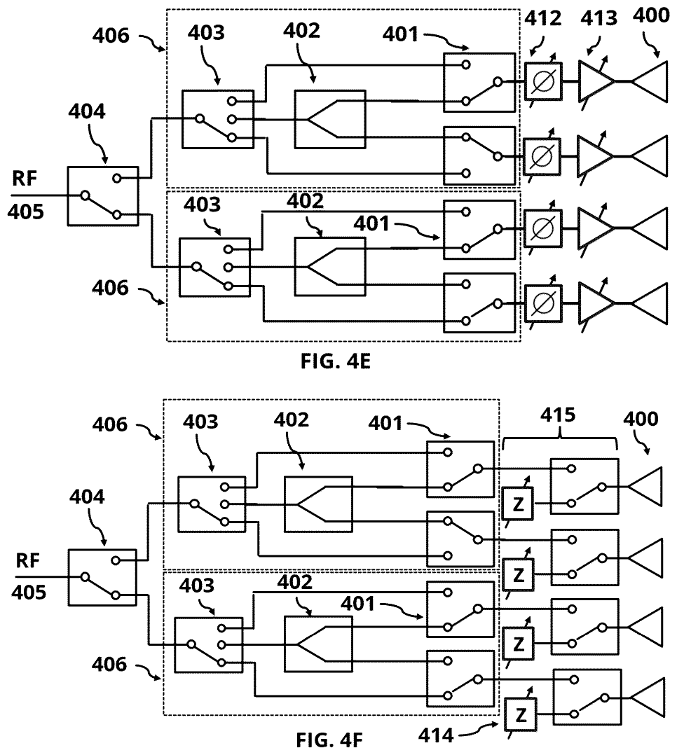

A simple non-restrictive embodiment is shown in FIG. 4A, in which an RF signal (405) is routed to one or more array elements (400). The RF signal is first routed to one or more “one-or-both-splitter(s)” (406) via an SPDT switch (404).

This subarray has three modes of operation depending on the state of the “backwards” SPDT switch 401 and the SP3T switch 403. In mode 1, the SP3T switch (403) is routed to the top of the three throws, while the backward SPDT switch (401) is also routed to the top—the signal is thus routed to the top antenna in the one-or-both-splitter's subarray. In mode 2, the SP3T switch 403 is routed to the bottom of the three throws, while the backward SPDT switches (401) are also routed to the bottom—the signal is routed to the bottom antenna in the one-or-both-splitter. In mode 3, the SP3T switch (403) is routed to the middle of the three throws, while the top switch (401) in the one-or-both-splitter (406) is routed to its bottom throw and the bottom switch (401) is routed to its top throw. The splitter (402) in the middle path then divides the incident signal evenly between the top and bottom antennas.

The splitter (402) may be implemented using a tee junction, Wilkinson combiner, or other equiphase splitting circuit.

FIG. 4B depicts a more complicated implementation of the switched splitter-combiner in which the SPDT switch (404) is replaced by a one-or-both-splitter (406).

This allows all of the antennas (400) to be excited with even magnitude by splitting the initial signal (405) into each of the one-or-both splitters (406) directly connected to the antennas.

Nevertheless, because the initial one-or-both-splitter can route the signal to either of the other two one-or-both splitters, 1, 2, or 4 antennas may be excited at a given time. The extension to a version of the switched splitter-combiner that can address anywhere from 1 to 2ⁿ antennas (400) is trivial.

FIG. 4C and FIG. 4D illustrate another embodiment of a switched splitter-combiner in which any two adjacent antennas (400) may be simultaneously excited. FIG. 4C shows a subcircuit of the embodiment, the “one-or-both-or-bypass” circuit (407). This circuit (407) is similar to the one-or-both-switch (406) except the backward SPDT switches (401) in the one-or-both-switch are now replaced by backward SP3T switches (408), which are exposed outside the subcircuit.

The one-or-both-or-bypass circuit (407) allows a signal incident (409) on the pole of the SP3T switch (403) to be routed to either of the of the outputs (410). However, it also allows the outputs (410) to be routed to the bypasses (411).

FIG. 4D shows the block diagram of the “any two adjacent antennas embodiment”. An SP6T switch comprising a cascaded SPDT switch (404) and SP3T switches (403) is routed to alternating splitters (402) or one-or-both-or-bypass circuits (407). The splitters (402) in turn feed the bypass routes (411) of the one-or-both-or-bypass circuits (407).

When the SP6T switch routes to a one-or-both-or-bypass-circuit, the signal may be routed to one or both of the antenna (400) connected to that circuit.

When the SP6T switch routes to one of the splitters (402), the splitter (402) feeds the bypass lines of the adjacent one-or-both-or-bypass circuits (408). Each one-or-both-or-bypass circuit may then route one of their connected antennas (400) to the signal.

As a result, this embodiment can excite any two adjacent antennas evenly while still allowing single-antenna excitation. A similar scheme is possible for the excitation of any number of adjacent antennas.

These embodiments also allow multi-adjacent feed excitations for advantageous coverage at the higher frequencies as opposed to solely enabling wide bandwidth operation.

When two adjacent feeds are excited, the resulting far-field beam is a superposition of the two original beams with far-field beam angle in-between that of the original beams. The resulting superimposed beam may have reduced directivity compared to either of its beams, which is potentially useful for applications such as rapid cell search procedures in commercial wireless base stations.

A hybrid switched splitter-combiner and phased array architecture is depicted in FIG. 4E. The architecture is identical to the embodiment depicted in FIG. 4A except that the RF conditioning (see (303), FIG. 3) following the switched splitter-combiner comprises a variable phase-shifter (412) and variable gain amplifier (413). Addition of these elements provides additional flexibility in the analog combining of radiation from adjacent feeds.

In some embodiments, the variable phase-shifter (412) and variable gain amplifier (413) may be modulated at rates commensurate with the bandwidth of the signal. In other embodiments, the variable phase-shifter (412) and variable gain amplifier (413) may even be modulated at rates commensurate with the signal's carrier frequency.

The embodiment of FIG. 4E may be generalized to any embodiment comprising portions of FIG. 4A-D, 4F, and any implementation implied by FIG. 3.

FIG. 4F depicts an embodiment in which non-excited feed elements may be terminated by an arbitrary impedance using the circuit (415), comprising an SPDT switch and a tunable impedance (414). Of particular interest are tunable impedances that are principally reactive, i.e. do not dissipate power. It should be understood that impedances may be passive, active, resistive, lossless, linear, nonlinear, or time-varying.

The tunable impedance (414) may mitigate the efficiency loss caused by mutual coupling. It may also be used to address any degradation in impedance match for excited elements.

In some embodiments, the tunable impedance (414) may be modulated at rates commensurate with the bandwidth of the signal. In other embodiments, the tunable impedance (414) may even be modulated at rates commensurate with the signal's carrier frequency.

As shown in FIG. 3, it is understood that a controller (305) is configured to select which of the modes of operation for the splitter-combiners (302) are active at a given point in time. The controller (305) may be implemented by one or more of a hard-wired logic circuit, Field Programmable Gate Array (FPGA), Application Specific Integrated Circuit (ASIC), programmed data processor, any combination thereof. If any of these implementations uses a stored program to implement the logic, the embodiments may comprise or utilize special purpose or general-purpose computers including computer hardware, such as, for example, one or more processors and system memory. These also include physical and other computer-readable media for carrying or storing computer-executable instructions and/or data structures. Such computer-readable media can be any available media that can be accessed by a general purpose or special purpose computer system. Computer-readable storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code in the form of computer-executable instructions or data structures and which can be accessed by a general purpose or special purpose computer. Transmission media include electromagnetic signals and carrier waves.

Computer-executable instructions may include, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or source code.

Therefore, the present invention may be embodied in other specific forms without departing from its spirit or essential characteristics. The described embodiments are to be considered in all respects only as illustrative and not restrictive. The scope of the present invention is, therefore, indicated by the appended claims rather than by the foregoing description.

1. An apparatus comprising:
an array of tightly coupled feed elements;
a switched splitter-combiner circuit coupled to a radio frequency (RF) port; and
a controller, configured to operate the switched splitter-combiner circuit such that RF power incident at the RF port is dynamically routed to all or a subset of the feed elements.

2. The apparatus of claim 1 wherein the controller is further configured to couple a selectable number of adjacent feed elements to be excited depending on a frequency of excitation and a degree of element-to-element coupling.

3. The apparatus of claim 1 wherein the RF power routed to each feed antenna is equal.

4. The apparatus of claim 1 wherein the RF power routed to each feed antenna is unequal.

5. The apparatus of claim 1 wherein the feed elements are further coupled to a lens.

6. The apparatus of claim 5 wherein the lens is a GRIN lens.

7. The apparatus of claim 1 wherein the feed elements are further coupled to a reflector.

8. The apparatus of claim 1 wherein the feed elements are coupled to an RF processing element to provide a power-scalable analog phased array, a hybrid phased array, or a wideband feed array.

9. The apparatus of claim 8 wherein the RF processing element includes one or more of transmit-receive switching, phase shifting, impedance matching, duplexing, low noise amplification, power amplification, or filtering.

10. The apparatus of claim 1 wherein any feed elements not excited by the switched splitter-combiner are terminated in impedances.

11. The apparatus of claim 10 wherein the impedances are tunable.

12. The apparatus of claim 10 wherein the impedances are passive, active, resistive, lossless, linear, nonlinear, or time-varying.

13. An apparatus comprising:
an array of tightly coupled feed elements;
a coupler circuit for selectively coupling one or more tuned impedances between a radio frequency (RF) port and one or more of the feed elements; and
a controller, configured to operate the coupler circuit such that RF power incident at the RF port is dynamically routed to all or a subset of the feed elements.

14. The apparatus of claim 13 wherein the tuned impedances are tunable in real-time.
